(19) United States
(12) Patent Application Publication
(10) Pub. No.: US 2005/0021242 A1
(43) Pub. Date: Jan. 27, 2005

(54) Data carrier for chemical or biochemical analyses

(76) Inventors: Manfred Wick, Tuebingen (DE); Ulrich rexhausen, Gomaringen (DE); Dominik Vogt, Koenigsbach (DE)

Correspondence Address: NATH & ASSOCIATES PLLC, 1030 FIFTEENTH STREET, N.W., SIXTH FLOOR, WASHINGTON, DC, 20005, US

(21) Appl. No.: 10/484,479

(22) PCT Filed: Jul. 29, 2002
(86) PCT No.: PCT/EP02/08419

(30) Foreign Application Priority Data
Jul. 27, 2001 (DE) 101-38-329.0

(51) Int. Cl. G01N 31/00

(52) U.S. Cl. 702/27

(57) ABSTRACT

The invention relates to a data carrier having memory locations to which data is written, wherein the memory locations have a number of first memory locations with erroneous data and at least one second memory location for the arrangement of analytical substances on the data carrier, wherein, when the analytical substances react with a medium that is to be investigated, the reaction product may cause a change to the data item which is written to the at least one second memory location, and the number of first memory locations is designed such that, on the one hand, when there is no reaction between the analytical substances and a medium which is to be investigated, a first data record can be determined when reading the data carrier and using a conventional error correction method, and, on the other hand, when the reaction product has caused a change to the data item which is written to the at least one second memory location, a second data record can be determined when reading the data carrier and using the conventional error correction method, with the second data record not being the same as the first data record.

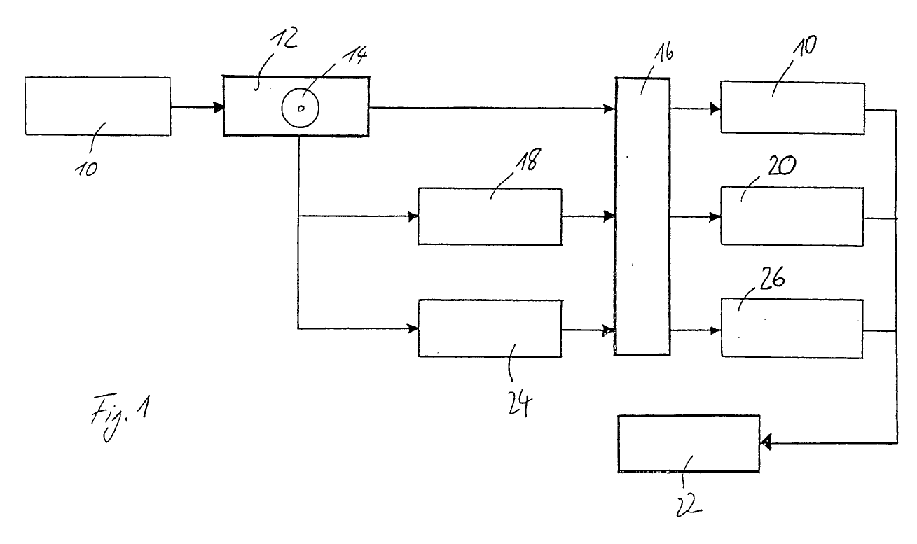

The present invention describes the format for carriers for chemical or biomedical analyses which can be read by means of conventional data readers. In this case, parts of the redundant information which is coded on the carrier are manipulated such that a change to the data can be detected clearly after writing. This is done by making use of characteristics of the redundant information protection methods, which operates on small data groups. The subsequent change to the data is in this case induced by means of a suitably designed chemical or biochemical test on the smallest information units in the data carrier. Carriers which are designed according to this invention can be used for a large number of parallel chemical or biochemical analyses. The major advantage in this case is the capability to use low-cost readers from the consumer goods industry, without any change.

### DETAILED DESCRIPTION OF THE INVENTION

With the current prior art for chemical or biomedical tests, microtiter plates or flat carriers derived from object carriers from microscopy and composed of plastic or glass are frequently used. For this purpose, sensor molecules are first of all immobilized in a defined arrangement in the depressions in the microtiter plates or on the surface of the carriers. This step requires sequential pipetting or spotting methods, which are limited both in time and spatially. The smallest spot diameters which can be held in this way have a diameter of about 80-100 μm and are inhomogeneous, because of the method. In the next step, the molecules on the spots must be brought into contact with the sample to be investigated. If the sample contains specific target molecules for the sensor molecules, then chemical bonding takes place on the carrier surface. The bonding which takes place in this way can be detected by suitable preparation of the sample, with the aid of fluorescence-spectroscopic or photometric methods. The restrictions to the fluorescence dyes with respect to emission intensities, quanta yield and bleaching response result in complex detectors and apparatuses for detaching the molecule spots which are applied to the carriers. The inhomogeniety of the individual spots frequently results in the necessity for subsequent, complex analysis of the primary data. The laboratory apparatus investment costs which result from this are restricting the more widespread use of the new test methods to a small number of fields of application such as pharmaceutical and principal research and, in particular, are restricting the wider use of modern methods in biomedical test laboratories, which are subject to the ever greater demands to make savings in medical supplies. The present invention indicates a way in which a cost-effective analysis method can be implemented by using established consumer goods technology and analysis carriers matched to the respective technology.

The invention will be explained in the following text using the example of compact discs. However, with a small number of changes, all optical data carriers such as CD, CD-R, CD-RW, DVD, DVD-RW as well as magnetic carriers such as floppy discs, replaceable discs or MOD disc drives or comparable media and their successors, which use redundant coding methods (Reed-Solomon, CRC—cyclic redundancy check or the like), may equally be used, in order to detect, and if appropriate to correct, a limited number of errors within defined information units.

The commercially available optical data carriers which are derived from audio-CDs are defined by the Philips Company Standard (Red Book, Philips). In this case, the applied information is first of all subdivided into higher-level structures. Distinctions are drawn between the so-called lead-in, table of content, data, blanks where appropriate and lead-out areas. Very small addressable data units are blocks with about 2 kilobytes of payload data. These are in turn subdivided into 98 small blocks, so-called F₃ frames, which are obtained from the original data using a multistage interleaving and scrambling method. One F₃ frame contains 24 bytes of payload data and 8 bytes of redundant parity data, which is calculated using the Reed-Solomon method. Audio CDs, for example, contain 6 audio samples in each case from the right and left audio channels (16 bits=2 bytes) per F₃ frame. The 8 bytes of parity data are used for error detection and error correction and included in the stream of payload data in real time when creating CD masters.

The production of CDs is based on a predetermined set of payload data (pieces of music, programs, data, etc) which, in the end, is intended to be recorded on the CD. First of all, in this case, a so-called glass master must be produced, which is used as a template for production of injection molds. A negative is first of all produced from this glass master by means of electrical nickel deposition, and a further positive is then produced from this negative. Finally, a negative which is derived from this is used as the molding element in an injection-molding machine.

The glass master is provided with a thin film of photoresist and is exposed, using a so-called laser beam recorder, to a defined sequence of light pulses on a spiral track. The sequence of light pulses is in this case produced by a computer program which, on the basis of the payload data and in accordance with the Red Book Standard, produces a series of shifts (interleaving), codings (Reed-Solomon) and transformations (scrambling and eight-to-fourteen modulation) in real time. The output from the program then controls the feed on the writing head, the rotation speed of the glass master and the modulation current for the laser beam. Since all of the control steps take place in software, it is possible to incorporate specific algorithms which are matched to the carrier according to the invention, by means of a simple change to the software. This means that it is possible to produce carriers which conform with the Standard, and whose specific characteristics additionally allow use for chemical or biochemical analysis.

Error Detection and Correction

The standard methods for error correction provide, in particular, two performance features:
the presence of errors and their position can be identified.
the order of magnitude of the errors can be determined.

These two statements are true only provided that the correction power of the method is not exceeded. In general, it can be stated that half as many errors can be corrected as can be identified. However, a fundamental precondition for this is that the actual payload data does not change, that is to say no changes occur to the data between two or more reader processes and any such changes can be explained by read errors.

Example of Error Correction

The example illustrates the principle which is used in the production of the carriers according to the invention, on the basis of a block of two data items and two parity data items
└D₁|D₂|P₁|P₂┘ (i a)
D₁=Data item 1
D₂=Data item 2
P₁=Checksum 1
P₂=Checksum 2

The parity data is chosen such that it satisfies the following simple equations:
P₁=D₁+D₂ (i b)
P₂=D₁+2D₂ (i c)

This means that P₁ is the sum of the two data items and P₂ is the sum of the first data item and twice the second data item, for example
└1|4|5|9┘ (ii a)

If an error is applied to one of the data items or to one of the parity data items, then this error can be identified and corrected provided that it is a single error, for example in this case, 6 instead of 4:
[1|6|5|9] (ii b)

That is because the equations (i) can also be formulated as follows, by subtracting P₁ and P₂ respectively from the two sides,
D₁+D₂−P₁=0 (ii c)
D₁+2D₂−P₂=0 (ii d)

In this example, it can immediately be seen that the data must be erroneous because
D₁+D₂−P₁=1+6−5=2 (iii a)
D₁+2D₂−P₂=1+12−9=4 (iii b)

Since a value other than zero is produced in both cases, the error cannot be in the parity data. If it were in P₁, the zero would have to appear in equation (iii b) and, conversely, in equation (iii a) if the error were in P₂.

If equation (iii a) is subtracted from equation (iii b), then this results in:
D₂−P₁+P₂=6−5+9=10 (iii c)
D₁+2D₂−P₂=1+12−9=4 (iii d)

The error in all these locations is accordingly in this form:
[F₁/F₂|0|0] (iii e)

That is to say:
F₁+F₂+0+0=2 (iii f)
F₁+2F₂+0+0=4 (iii g)

These equations are solved to produce:
F₁=0 (iii h)
F₂=2 (iii i)

In consequence, we know that the error value 2 must be subtracted at the location of the second data item in order to obtain the original data.

Application to Chemical or Biochemical Tests

For conventional data carriers, static data is generally used, which no longer changes after it has been written (or after the CDs have been produced). Each reading process should thus give the same result, except for any damage to or dirt on the data carrier.

A modification to the data stream when using a predetermined error correction method makes it possible to work with polymorphic data to a limited extent. This means that the data can change in a determined manner between two reading processes despite the error correction at individual locations.

This is the situation, for example, when a different type of representation is scattered into the static, physically represented data and is used for the purpose according to the invention of chemical or biochemical verification. This may, for example, have a positive or a negative result, and a physical representation which is adequate for the data reader must be produced in a corresponding manner after the test. The interpretation of the physical structure produced in this way is thus polymorphic as a function of the result of the chemical or biochemical verification.

The principle of the data carriers according to the invention is now to provide the static data deliberately with errors, which are eliminated by the error correction method in the reader. An additional error, generated by the polymorphic representation of a chemical or biochemical test, then exceeds the correction capabilities of a given error correction method, and the interpretation of the corrected data does not match the interpretation of the data without the chemical or biochemical test.

This makes it possible easily to distinguish between different situations without having to manipulate the existing correction methods which are implemented in standard appliances or applications. All that is necessary is to prepare the carriers for the chemical or biochemical test. This allows the use of existing hardware such as CD players and derivatives as well as all known magnetic and magneto optic readers.

Example Relating to Manipulation of the Error Correction

In the method according to the invention, it is accepted that the error correction capability is lost in order, instead of this, to detect a chemical or biochemical reaction. The error correction is thus exchanged for the capability to make a decision between two values at one of the four locations. This is done by first of all deliberately applying an error to the data
[1|6|5|9] (iii j)

From the above example, it is clear that these four values relating to the original data:
[1|4|5|9] (iii k)
can be corrected if there is only one error in one of the four data items. The error −2 is now additionally incorporated in the first data item:
[−1|6|5|9] (iii l)

The two errors exceed the correction power of the method. Nevertheless, the equations can be solved from above:
D₁+D₂−P₁=−1+6−5=0 (iv a)
D₁+2D₂−P₂=−1+12−9=2 (iv b)

Analogously to the previous example, it can easily be calculated that an error of magnitude −2 at location P₂ gives the same results in equation (iv a) and equation (iv b). This means that −2 is subtracted from P₂ thus producing the supposedly correct data
[−1|6|5|11] (iv c)
which now in fact contains an error in three locations.
P₁=D₁+D₂=−1+6=5 (iv d)
P₂=D₁+2D₂=−1+12=11 (iv e)

Thus, summa summarum, the deliberate error in D₂ lead to a second error in D₁ deciding whether, in the end, the original data is produced or data which differs from the original data in three locations.

Advantages

Errors can still be identified.

Polymorphic data can be read.

Disadvantage

The error correction power is lost.

General Description of the Method

From the mathematical point of view, conventional error correction methods are based on the solution of equation systems for which parity data is calculated. In general, n equations are required, when n/2 errors are intended to be correctable. The equations can always be written in the form:
f₁(x)=0
f₂(x)=0
fₙ₋₁(x)=0
fₙ(x)=0 (v a)
where x is the vector of the data including the parity data. As a rule, in comparison to the payload data, the parity data represents only a relatively small proportion of the overall data. Methods such as these are widely used nowadays.

The class of methods described can be modified such that they can lose their error correction power but can make use of polymorphic data for this purpose. The modification described in the following text therefore does not involve the method itself, but only the data and parity data. This results in the advantage that the modification can be incorporated in error correction methods which have been implemented in already existing applications (hardware, software, etc.).

This is based on the principle of using error correction methods which satisfy the following preconditions:
the correction method can be represented as an equation system in the above form and accepts any desired input data
the amount of payload data is larger than the amount of parity data.

If the data has errors at at most n locations, then the method always reproduces the corrected original data. This is no longer the case if errors occur at more than n locations.

The idea of polymorphic data storage is now to deliberately render the error correction of the basic method inoperative. Every error correction method is based on the same fundamental idea: correct data can be represented as points in a mathematical space. The closer the points are located, the more similar the data items are. Between these points, there are a large number of other points which represent erroneous data, that is to say data whose parity data is not correct, that is to say this data does not solve the associated equation system. An error correction method will now always attempt to replace an erroneous data point by the closest correct data point in space.

If the data is deliberately manipulated such that the associated data point is located in the area close to the center between two or more correct data points in that area, small changes in the data (polymorphic data) can lead to the input data being moved from one or other correct data point. In the process, the correction power of the method is lost, but not the error identification.

Specific Definition

The CD will now be used as an examplary embodiment of a data carrier for the Reed-Solomon (RS) method which is implemented at the F₃ frames level. An F₃ frame comprises 32 bytes of data, of which 28 bytes are payload data and 4 bytes are parity data. The RS method allows errors in at most two bytes to be corrected. The equation system for calculation of the parity data is linear and can thus be represented as a matrix multiplication:
f(X)=0 (vi a)
or
M·x=0 (vi b)
where M is the matrix associated with the method and x is the vector comprising the data. In order to avoid making the calculation unnecessarily complicated, the specific values are dispensed with here.
f([D₁|D₂|D₃ . . . D₃₁|D₃₂])=0 (vi c)

Analogously to the above example, the predefined errors E₁ and E₂ are introduced, for example, at the locations 1 and 2:
f([E₁|E₂|0| . . . 0|0])≠0 (vi d)

The RS method can correct errors at a maximum of two locations and will in this situation nevertheless return the original vector, that is to say it will correct the errors E₁ and E₂. As soon as a further error E₃ is added at a third location 3, the method is overloaded and can normally no longer carry out sensible corrections:
f([E₁|E₂|E₃| . . . 0|0])≠0 (vi e)

Intrinsically, there is no gain yet. A major step now is not to take random values E₁, E₂, E₃, but to choose these in such a matter that, for a suitable choice of two further values E₄ and E₅, then:
f([E₁|E₂|E₃|E₄|E₅|0| . . . |0])=0 (vi f)

On the basis of the preconditions which had been placed on the method, this is possible for any given locations in the data. Since RS methods are linear methods, then:
f([E₁|E₂|E₃|0|0| . . . |0|])=f([0|0|0|−E₄|−E₅| . . . |0|0]) (vi g)

The disturbance at the locations E₁, E₂ and E₃ is thus equivalent to a disturbance only at E₄ and E₅. The RS method will therefore now not correct the three disturbances E₁, E₂, E₃ but, in contrast, will also add the additional errors E₄ and E₅. In the application, E₁ to E₅ are already known and can be compared with the data that is read.

The correct choice of the values E₁ to E₅ depends on the specifically chosen method. In the case of linear methods, the linear equation system can be solved by elementary linear algebra means.

With regard to the actual application of the CD, the method described above still requires the solution of the problem of dirt or damage to the CD surface, which will interfere with the method as additional errors.

This could be protected against by inserting further data within the F₃ frame, with which, for example, it is possible to repeat the values of the locations 1 to 5 for additional protection. Although a reading disturbance at any given point in the F₃ frame will now admittedly result in a more or less random error pattern in the data that is read, the RS method algorithm will, however, ensure that this data generally differs significantly from the expected data format. Although the result of the polymorphic data item at the location 3 is thus lost, there is a high probability of this loss being identified so that any desired statistical confidence level can be achieved by multiple repetition of this data item. The probability of random dirt on the CD appearing to simulate a correct result is no greater than in the case of normal CDs. With regard to CDs as data carriers, multiple repetition of this method or of a variant is necessary, since the content of a CD is protected by a number of error correction stages.

In an extension of the procedure described above, even complex, multistage errors can be detected within a data unit. Likewise in an extension of the present invention, it is feasible to accommodate two or more chemical or biochemical tests within one data unit. Both possibilities are thus part of the invention.

Addressing of Molecules on Surfaces

The method described above can now be used in the context of a chemical or biochemical test on the CD surface. For this purpose, the intended errors E₁ and E₂ must first of all be accommodated in the data stream which is applied to the CD surface in the form of pits and lands. This is done by means of suitable software in the described processing of the stream of payload data during the production of the glass master. Molecules which are used as a sensor during the test are then applied on the surface of the CD in the structures which represent the data E₃. The optical verification method which indicates a bonded target molecule is in this case optimized for the pickup of a conventional CD player. If a positive test now takes place within the data E₃, then this is interpreted by the decoding electronics of the CD player as an error, and the described correction method comes into action. Since all of the conditions other than E₃ are kept constant, the result of the chemical test in E₃ can be deduced directly from the result which is produced from the correction method. This makes it possible to carry out a large number of individual tests (approximately 30 million) in the context of the standard data format of CDs (Red Book). The field of application is limited only by the logistics of the different molecules and their arrangement within the available F₃ frames. From the reader point of view, this therefore results in the simplest feasible case, that is to say the use of CD data and audio players which are known from consumer electronics. There is no need to modify the software, firmware or even the hardware.

In addition to inorganic and organic chemical substances, biomolecules, in particular, may also be used as sensor molecules.

It is likewise possible to provide a data carrier with a predetermined number of memory locations with incorrectly written data, which is designed such that, on the one hand, the maximum number of errors which can be corrected using a conventional error correction method is exceeded while, on the other hand, the data record which can be determined after reading the data carrier and using the conventional error correction method is determined. On the basis of the knowledge of the values which have been deliberately written incorrectly to the memory locations, and knowledge of the error correction method, the errors contained therein can be corrected retrospectively by subsequent treatment of the data record which is determined when reading the data carrier. In conjunction with corresponding subsequent treatment software, for example, a data carrier such as this can be used for the protection of costly programs since the program can be read from the data carrier without errors only by means of the subsequent treatment software.

Further features and advantages of the invention can be found in the claims and the following description in conjunction with the drawing. In the drawing:

the single FIGURE shows a schematic illustration in order to illustrate the steps which are expedient for production of the data carrier according to the invention, and for its use.

In order to produce the data carrier according to the invention, a first data record 10 is stored, for example, on an optical compact disc 14, in a step 12. The first data record in this case contains so-called useful bits and parity bits, and does not contain any erroneous data. During the storage process, certain data items in the first data record 10 are changed in a predetermined manner. For example, a value 6 is stored instead of a value 4. The data which is stored on the CD 14 in consequence contains errors. However, in embodiment of the invention, the number of errors is set such that it corresponds to the maximum number of errors which can be corrected by means of a conventional error correction method. All the errors can thus be corrected by means of a conventional error correction method when reading the CD 14. When reading the CD 14 in the step 16 without the biochemical test in the step 18 having been carried out, the first data record 10 is thus once again determined.

However, it is only of secondary importance whether the original data record 10 which existed before the introduction of the errors is actually determined when reading the CD 14, provided that the first data record that can be read in the step 16 is determined. For example, in a further embodiment of the invention, the maximum number of errors which can be corrected on the data carrier can be exceeded after the data has been written in the step 12. When reading the data carrier in the step 16, a further, determined, first data record is then determined rather than the original data record. When carrying out an analysis in the step 18, the data on the data carrier must in this case be modified such that a second determined data record, which is not the same as the first data record, is determined when reading the data carrier. For example, the maximum number of errors which can be corrected can be exceeded again by changing the data during the analysis in the step 18.

Furthermore, in the step 12, analytical substances are applied at predetermined memory locations on the CD 14. As has been stated, the compact disc 14, which is provided with analytical substances and is written in this way can be read in the step 16 by means of a commercially available reader.

If the CD 14 is brought into contact with a medium to be investigated, for example in order to carry out a biochemical test in the step 18, the analytical substances may react with the medium being investigated. Further process steps, for example of a chemical nature, may be required in the step 18 in order to result in the reaction product producing a change in the data at the memory locations which contain the analytical substances. The change in the data thus results in further memory locations with erroneous data. Since this exceeds the maximum number of errors which can be corrected on the CD 14, a second data record 20 is determined rather than the original data record 10 by means of the reader after a reaction in the step 18. This second data record 20 is not the same as the first data record 10. This second data record 20 is also determined, since the deliberately erroneously written data, the error correction method and the change to the data resulting from a possible reaction in the step 18 are unknown. If the second data record 20 is thus determined when reading the CD 14, it can be deduced that the analytical substance has reacted with the investigated medium.

If, on the other hand, the first data record 10 is once again determined after application of the substance to be investigated and after carrying out step 18, no reaction has occurred between the analytical substance and the investigated medium, and the data on the CD 14 has not been changed in the step 18. The critical factor for the assessment of the biochemical test carried out in the step 18 is thus to distinguish between the first data record 10 and the second data record 20.

If, in a further embodiment of the invention, the number of first memory locations on the data carrier with incorrectly written data is less than the maximum number of errors which can be corrected by means of the error correction method, two or more memory locations must be provided with possibly different analytical substances so that, in the event of a reaction at all the memory locations between analytical substances and the investigated medium, the maximum number of errors which can be corrected is exceeded. By way of example, analyses can be logically linked such that the maximum number of errors which can be corrected is exceeded only when the investigated medium reacts both with a first analytical substance and with a second analytical substance.

However, if an undefined third data record 26 is determined when reading the CD 14 after application of the substance to be investigated and after carrying out the step 18, it is possible to deduce that there is an additional error which, for example, has been caused by dirt on the data carrier. Dirt on the CD 14 or the occurrence of other errors, such as manufacturing errors or the like, is symbolized by the step 24. In this case, the number of and/or the data in erroneous memory locations will differ from the situation described above. The third data record 26 determined in the step 16 thus differs not only from the original data record 10 but also from the second data record 20. This third data record 26 must be rejected as being invalid. This maintains the confidence level against the possibility of additional errors.

In order to increase the confidence level, the same analysis is carried out a number of times on the data carrier, and the data records determined on reading are evaluated statistically. The data records 10, 20 and 26 are compared in a step 22. The comparison result in the step 22 is used to determine whether the analytical substances on the CD 14 have reacted with the investigated medium, that is to say whether the biochemical test result is positive or negative, or whether the data record 26 is invalid.

1. A carrier for application of substances for analytical purposes, characterized by:
a data track corresponding to that used in known mass data stores (CD-audio, CD-ROM, CD-R, CD-RW, DVD, magnetooptical storage media, hard disks, replaceable disks, all derivatives of them as well as magnetic tapes and bar code readers), with
the data track being structured into data blocks and optional structure elements thereof,
data being represented by information units, and
the information units being represented by a physical structures on the carrier,
at least one predefined information unit within at least one data block or its subunit;
the use of error correction methods, wherein
parity data is used,
the parity data can be calculated by solving homogeneous equation systems,
the parameters of the equation systems are parity data and/or data,
defined areas within a sequence of physical structures which represent at least one information unit on which sensor molecules are immobilized, with the result of a chemical or biochemical test which is carried out with the sensor molecules having these additional errors after the test in the interpretation of the physical structures as information units, and/or errors which were present before the test being corrected after the test;
a determined interaction of predefined errors in information units and by means of errors which are produced or corrected after a test by interpretation of areas of physical structures which are provided with sensor modules, such that the sum of the error points and test points in information units in total exceeds the correction capability of the error correction method that is used;
the possibility for a unique interpretation capability of the information units, which are supplied from the respective reader, in a data block or its subunits with regard to the test result by comparison with a previously known reference value, so that the characteristics of the reader have no influence on the interpretation in given error correction methods.

2. The data carrier as claimed in claim 1, wherein at least one defined error is inserted in at least one information unit within data blocks or subunits of data blocks as a function of the error correction methods which are used for reading the data.

3. The data carrier as claimed in claim 1, wherein a Reed-Solomon code is used for the error correction method.

4. The data carrier as claimed in claim 1, wherein a CRC (cyclic redundancy checksum) is used for the error correction method.

5. The data carrier as claimed in claim 1, wherein the data track is applied in the form of a line or a grid, in the form of concentric circles, in a spiral shape or in other linear or area patterns.

6. The data carrier as claimed in claim 1, wherein additional data ensures the protection of the test data against misinterpretation by dirt on the carrier surface, in particular, redundant repetitions of the predefined data.

7. The data carrier as claimed in claim 1, wherein predetermined statistical protection for the test validity is ensured by means of a correspondingly large number of repetitions, in particular 2 to 10 7, of the individual tests.

8. The data carrier as claimed in claim 1, wherein quality inspection and standardization of the bonding characteristics of a given test can be carried out by means of standard substances which are applied to the carrier.

9. The data carrier as claimed in claim 1, wherein information about the chemical or biochemical test which is applied to the carrier is also included in the data.

10. The data carrier as claimed in claim 1, wherein once the chemical or biochemical test has been carried out, parts of the carrier may also record the results which are produced by the test in accordance with a conventional method (magnetic or magnetooptic memory, hard disks, CD-R or CD-RW and mixed forms of them).

11. The data carrier as claimed in claim 1, in which mixed forms of at least two data memories as cited in the preceding claim may be used.

12. A carrier having locally different amounts of sensor molecules, wherein these amounts are chosen such that the number of errors which are produced by reaction with the sensor molecules can be used to deduce the concentration of substances which react with the sensor molecules.

13. The carrier as claimed in claim 1, wherein further data fields are included in addition to the data fields which are used for analytical tests and include information for the further evaluation of the tests, in particular software for creation of calibration curves, interpretation and analysis of data, recording of further data and its graphical representation and storage, and matching to external data from networks.

14. A kit, including the major substances for carrying out one or more analyses with the carrier as described in claim 1.

15. A data carrier having memory locations to which data is written, wherein the memory locations have a number of first memory locations with erroneous data and at least one second memory location for the arrangement of analytical substances on the data carrier, wherein, when the, analytical substances react with a medium that is to be investigated, a reaction product may cause a change to the data item which is written to the at least one second memory location, and the number of first memory locations is designed such that, on the one hand, when there is no reaction between the analytical substances and a medium which is to be investigated, a first data record can be determined when reading the data carrier and using a conventional error correction method, and, on the other hand, when the reaction product has caused a change to the data item which is written to the at least one second memory location, a second data record can be determined when reading the data carrier and using the conventional error correction method, with the second data record not being the same as the first data record.

16. The data carrier as claimed in claim 15, wherein the erroneous data has predetermined values, such that both the first data record and the second data record are determined.

17. The data carrier as claimed in claim 15, characterized in that the number of first memory locations with erroneous data corresponds to the maximum number of errors which can be corrected by the error correction method.

18. The data carrier as claimed in claim 15, characterized in that two or more second memory locations are provided with analytical substances, with the analytical substances reacting in different second memory locations for different concentrations of the medium that is to be investigated.
